(19) United States
(12) Patent Application Publication
(10) Pub. No.: US 2013/0119281 A1
(43) Pub. Date: May 16, 2013

(54) PHOTOELECTRIC DETECTOR WITH MOS GAS SENSOR

(71) Applicant: SCOTT R. LANG, Geneva, IL (US)

(72) Inventor: SCOTT R. LANG, Geneva, IL (US)

(73) Assignee: Honeywell International Inc., Morristown, NJ (US)

(21) Appl. No.: 13/293,665

(22) Filed: Nov. 10, 2011

(51) Int. Cl. G01N 21/53

(52) U.S. Cl. 250/564

(57) ABSTRACT

A dual sensor fire detector includes a smoke sensor and a gas sensor. A source of radiant energy emits a beam which is formed into first and second beams. One beam is directed into a smoke sensing chamber. The other is directed to a gas sensor. Outputs from the smoke sensor and the gas sensor are combined to make a fire determination.

### FIELD

The application pertains to fire detectors. More particularly, the application pertains to such detectors which incorporate both a photoelectric smoke sensor and a solid state gas sensor.

### BACKGROUND

There are several types of photoelectric smoke detector. Most detectors use only forward scattering detectors with a light source in the near infrared. Some detectors use a dual angle sensing chamber, which measures both the forward and backward light scattered from particles in order to gain some insight into particle size.

Some detectors use more than one wavelength of light. Others use a combination of angles and wavelengths. Some detectors use a photoelectric sensing chamber combined with heat, gas, or light sensing, i.e., multi-criteria smoke detectors. One example of a photoelectric smoke sensor is disclosed in U.S. Pat. No. 6,521,907, entitled “Miniature Photoelectric Sensing Chamber” which issued Feb. 18, 2003. One example of a multi-criteria detector is disclosed in U.S. Pat. No. 6,967,582, entitled Detector With Ambient Photon Sensor and Other Sensors, which issued Nov. 22, 2005. Both the '907 and the '582 patents are owned by the Assignee hereof and incorporated herein by reference.

Photoelectric smoke sensors that use near infrared light (850 to 950 nm) are generally known to be better at detecting smoldering fires since those types of fires produce larger particles. Ionization type smoke sensors tend to detect flaming fires better. Ionization sensing chambers are better at detecting the small particles produced by the flaming fires. Ionization based detectors are falling out of favor due to increased environmental regulations.

Smoke detectors are commercially available that use blue light emitting diodes (LED's). When blue LED's are used in forward scattering photoelectric smoke sensing chambers, the sensor's response to small particles improves. This is predicted by Mie scattering theory, which says that particles will preferentially scatter light in the forward direction when the wavelength of light approaches the particle size. Small particles are typically produced by flaming fires.

At least some known photoelectric smoke sensors include an optic block that carries a light source, such as an LED, and a light sensitive element, such as a photodiode. The source and sensor are arranged at a prescribed angle to one another in order to detect scattered light. A housing surrounds the block and serves to exclude ambient light and direct the flow of ambient airborne particulate matter.

MOS (metal oxide semiconductor) gas sensors are typically heated to 200 to 400° C. for proper operation. This required heating can be achieved by using a resistance heater, causing high power consumption. Some thick film MOS gas sensors draw up to 500 mW, while thin film or MEMS devices may draw an order of magnitude less. This high power consumption limits the number of applications where they can be used. For example, system connected fire detectors require low power consumption due to battery backup requirements in the National Fire Alarm Code.

MOS gas sensors also tend to not be selective to one gas, but sensitive to a whole class of gases, e.g., oxidizing gases. Radiant energy can be directed onto such sensors to increase their sensitivity instead of heating them. Doing so reduces the amount of power required to operate them.

### BRIEF DESCRIPTION OF THE DRAWINGS

FIG. 1 is a block diagram of a multi-sensor fire detector in accordance herewith; and

FIG. 2 is an enlarged perspective view of a mounting block usable in the detector of FIG. 1.

### DETAILED DESCRIPTION

While disclosed embodiments can take many different forms, specific embodiments hereof are shown in the drawings and will be described herein in detail with the understanding that the present disclosure is to be considered as an exemplification of the principles hereof, as well as the best mode of practicing same, and is not intended to limit the claims hereof to the specific embodiment illustrated.

In one aspect hereof, a smoke sensing chamber includes a blue or UV light source where the light source is used not only for measuring particles of smoke with light scattering, but also enhancing the operation of an MOS gas sensor. Flaming fires can be detected if the gas sensor oxide is chosen to be WO₃ for NO₂ detection, since flaming fires produce NO₂. Alternately, if SnO₂ is chosen for the oxide, to sense CO, both smoldering and flaming fires could be detected.

Light, or radiant energy, from the light source is directed in two directions such that it creates the necessary scattering volume for the photoelectric sensing chamber and it shines on the MOS gas sensor's gas sensitive oxide in order to enhance operation thereof. In another aspect, the source can be intermittently activated to reduce power requirements. In an alternate embodiment, two different sources, activated intermittently could be used.

Radiant energy from the source can be divided into beams. One beam can be directed into the scattering volume. The other can be directed at the gas sensor.

An optical or mechanical element can be used to form two different beams. One optical element is a beam splitter. Wavelengths for the emitted radiant energy can range from blue (465 nanometers) to ultraviolet (365 nanometers).

The MOS gas sensor may be heated, but at a lower level than is ordinarily required or not heated at all. The gas sensor may be occasionally heated in order to clean the sensor and restore it to a baseline condition. Advantageously, various different oxides may be used in the MOS gas sensor including tin oxide, tungsten oxide, chrome titanium oxide, etc. depending on what gases need to be sensed.

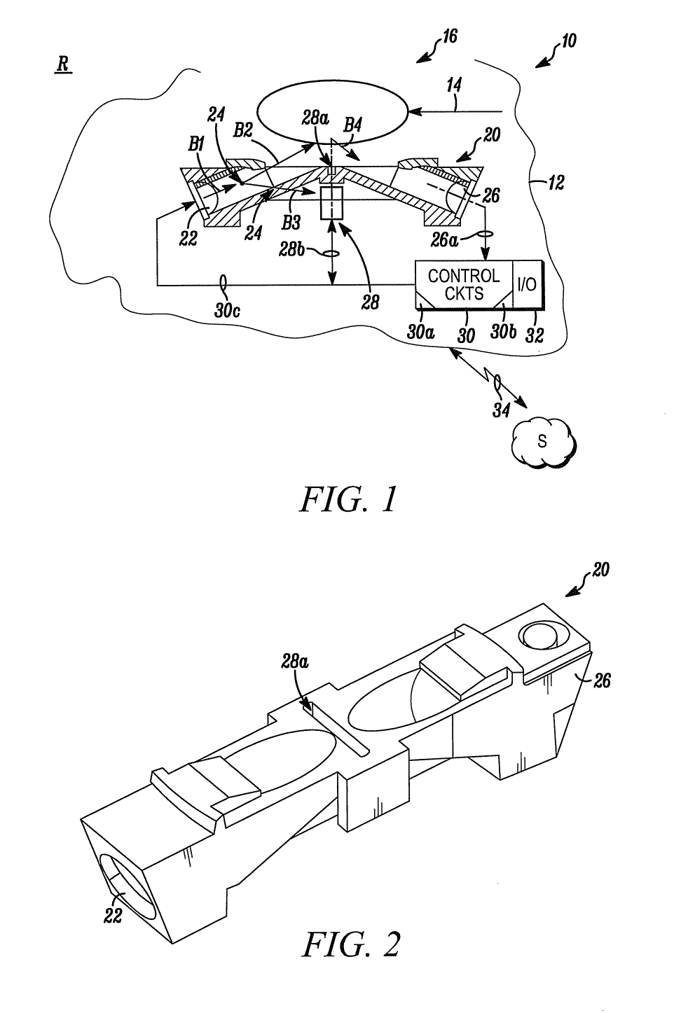

FIGS. 1, 2 illustrate various aspects of an exemplary dual sensor fire detector 10 in accordance herewith. Detector 10 can be carried in a housing 12 which defines an internal scattering volume 14. Housing 12 defines openings 16, as would be understood by those of skill in the art to provide for ingress of ambient airborne particulate matter, for example smoke from a fire in an adjacent region R being monitored by detector 10, along with gases produced by such fire.

Housing 12 also carries a mounting, or optical block 20. Block 20 in turn carries a source of radiant energy 22, a blue emitting LED or laser with a wavelength in a range as discussed above. Source 22 emits radiant energy as a beam B1 directed to a divider element 24. Divider element 24, which could be mechanical or optical such as a beam splitter, forms two different beams B2, B3.

Beam B2 is directed into the scattering volume 14. Light scattered by airborne smoke particulate, indicated generally as B4 is incident on a photosensor 26.

Beam B3 is incident on a metal oxide gas sensor 28, and activates that sensor to respond to gases that enter the housing 12, and via a pathway 28a, and are incident on the sensor 28, as discussed above.

Control circuits 30, carried by housing 12 could be implemented in part by a programmable processor 30a which executes pre-stored control circuitry 30b, present in a non-transitory computer readable storage medium. The control circuits 30 are coupled to source 22 to activate same via conductor 30c.

Control circuits 30 receive gas indicating signals, via conductor 28b, and smoke indicating signals via conductor 26a. Signals on the lines 28b, and 26a can be processed to make a fire determination.

Input/output interface circuits 32, coupled to control circuits 30 communicate with a displaced alarm system S, via a wired or wireless medium 34.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. A fire detector comprising:
at least one source of radiant energy;
a radiant energy scattering region; and
a solid state gas sensor wherein selected radiant energy is directed into the scattering region and other radiant energy is directed onto the gas sensor.

2. A detector as in claim 1 which includes an element to form two beams from the one source.

3. A detector as in claim 2 which includes a mounting block for the source, and a sensor of scattered radiant energy.

4. A detector as in claim 3 which includes a housing for the source and the gas sensor wherein openings defined in the housing couple ambient atmosphere into the scattering region.

5. A detector as in claim 4 which includes a passageway coupling ambient atmosphere onto the gas sensor.

6. A detector as in claim 2 where one of the beams activates the gas sensor.

7. A detector as in claim 1 where the source comprises one of a light emitting diode, or, a laser.

8. A detector as in claim 1 where the gas sensor comprises a metal oxide semiconductor.

9. A detector as in claim 1 where radiant energy is emitted at a wavelength in a range of 450 to 480 nanometers.

10. A detector as in claim 1 which includes a heater for the gas sensor.

11. A detector as in claim 2 where the source and a sensor of scattered radiant energy are carried on a mounting block, spaced apart from one another, wherein one beam is directed into the scattering region by the element.

12. A detector as in claim 11 where the element comprises at least one of an optical former of the beams or a mechanical former of the beams.

13. A detector as in claim 12 where the optical former comprises a beam splitter.

14. A detector as in claim 11 where the gas sensor comprises a metal oxide semiconductor and where radiant energy is emitted at a wavelength in a range of 450 to 480 nanometers.

15. A detector as in claim 14 which includes control circuits to activate the source, at least intermittently.

16. A detector as in claim 15 where the control circuits include a heater for the gas sensor and wherein the control circuits activate the heater, at least intermittently.

17. A multi-sensor fire detector comprising:
at least one source of radiant energy;
a radiant energy scattering region;
a solid state gas sensor wherein selected radiant energy is directed into the scattering region and other radiant energy is directed onto the gas sensor;
a mounting block for the source, and a sensor of scattered radiant energy;
where the source comprises one of a light emitting diode, or, a laser,
where radiant energy is emitted at a wavelength in a range of 450 to 480 nanometers; and
which includes control circuits to activate the source, at least intermittently and to receive signals from the gas sensor and the sensor of scattered radiant energy.

18. A detector as in claim 17 where the other radiant energy substantially activates the gas sensor.

19. A detector as in claim 17 which includes an element to form first and second beams of radiant energy.

20. A method comprising:
providing a beam of radiant energy;
forming first and second beams;
directing one beam to a scattering and the other beam to a gas sensing region;
forming electrical signals indicative of sensed scattering and sensed gas; and
evaluating the signals for the presence of fire.
